(19) United States
(12) Patent Application Publication
(10) Pub. No.: US 2025/0063499 A1
(43) Pub. Date: Feb. 20, 2025

(54) SLEEP MODE POWER SAVING FOR LAYER 1 AND RADIO UNIT EQUIPMENT

(71) Applicant: Dell Products L.P., Round Rock, TX (US)

(72) Inventors: Ilya Portnik, Ashton (CA); Tomasz Podsiadlik, Dublin (IE); Eran Goldstein, Montreal (CA); Jayaram Venguduswamy Srinivasan, Nepean (CA)

(21) Appl. No.: 18/451,157

(22) Filed: Aug. 17, 2023

(51) Int. Cl. H04W 52/02; H04W 72/0446

(52) U.S. Cl. CPC H04W 52/0216; H04W 72/0446

(57) ABSTRACT

A method for sleep mode power saving in Layer 1 and radio unit equipment includes facilitating, by a device including a processor, altering a communication schedule of physical layer equipment, associated with a cell of a communication network, from an active schedule to a sleep schedule in response to no user equipment being determined to be actively connected to the cell, where the sleep schedule repeats at intervals of a period and includes active time slots and inactive time slots. The method further includes, in response to the facilitating of the altering, scheduling, by the device, transmission of a network connection message by the physical layer equipment during an active time slot of the active time slots, and deactivating, by the device, the physical layer equipment during an inactive time slot of the inactive time slots.

### BACKGROUND

In Fifth Generation (5G) and/or other wireless communication networks, a base station is configured for continuous operation to enable transmission and reception of signals that enable a user equipment (UE) to connect to the network. These signals can include, e.g., a Synchronization Signal Block (SSB) and a first System Information Block (SIB1) on the downlink transmit side as well as a Physical Random Access Channel (PRACH) on the uplink receive side. In some use cases, processing of these signals can consume a considerable amount of the power budget of a base station and/or its associated equipment.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include a memory that stores executable components and a processor that executes the executable components stored in the memory. The executable components can include a mode selection component that sets physical layer equipment, associated with a cell of a communication network, in a low-power mode based on an indication that a number of user equipment devices actively connected to the cell is no greater than a threshold number. The low-power mode can be associated with a periodic pattern that includes an active time slot and an inactive time slot. The executable components can further include a power management component that, in response to the physical layer equipment being set in the low-power mode, schedules communication of network connection information by the physical layer equipment during the active time slot and deactivates at least a portion of the physical layer equipment during the inactive time slot.

In another implementation, a method is described herein. The method can include facilitating, by a device including a processor, altering a communication schedule of physical layer equipment, associated with a cell of a communication network, from an active schedule to a sleep schedule in response to no user equipment being determined to be actively connected to the cell. The sleep schedule can repeat at intervals of a period and include active time slots and inactive time slots. The method can additionally include, in response to the facilitating of the altering, scheduling, by the device, transmission of a network connection message by the physical layer equipment during an active time slot of the active time slots and deactivating, by the device, the physical layer equipment during an inactive time slot of the inactive time slots.

In an additional implementation, a non-transitory machine-readable medium is described herein that can include instructions that, when executed by a processor, facilitate performance of operations. The operations can include assigning a low-power communication schedule to Layer 1 equipment associated with a cell of a communication network based on an indication that a number of network devices actively connected to the cell is less than a threshold number, where the low-power communication schedule repeats at intervals of a period and includes an active time slot and inactive time slots; and, in response to the assigning, facilitating transmission of network attachment information by the Layer 1 equipment during the active time slot and disabling at least a portion of the Layer 1 equipment during the inactive time slots.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram illustrating a system that facilitates sleep mode power saving for Layer 1 (L1) and radio unit (RU) equipment in accordance with various implementations described herein.

FIGS. 2-3 are diagrams depicting respective communication schedules that can be utilized in various implementations described herein.

FIGS. 4-6 are block diagrams illustrating additional systems that facilitate sleep mode power saving for L1 and RU equipment in accordance with various implementations described herein.

FIG. 7 is a diagram depicting another communication schedule that can be utilized in various implementations described herein.

FIGS. 8-9 are block diagrams illustrating further additional systems that facilitate sleep mode power saving for L1 and RU equipment in accordance with various implementations described herein.

FIG. 10 is a flow diagram of a method that facilitates sleep mode power saving for L1 and RU equipment in accordance with various implementations described herein.

FIG. 11 is a flow diagram depicting respective operations facilitating sleep mode power saving for L1 and RU equipment that can performed by a processor in accordance with various implementations described herein.

FIG. 12 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

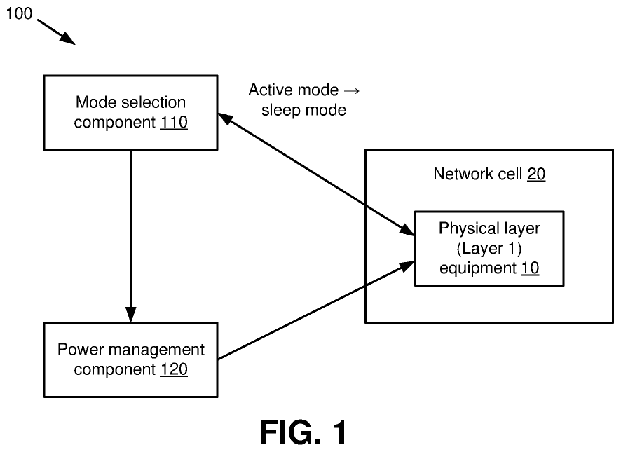

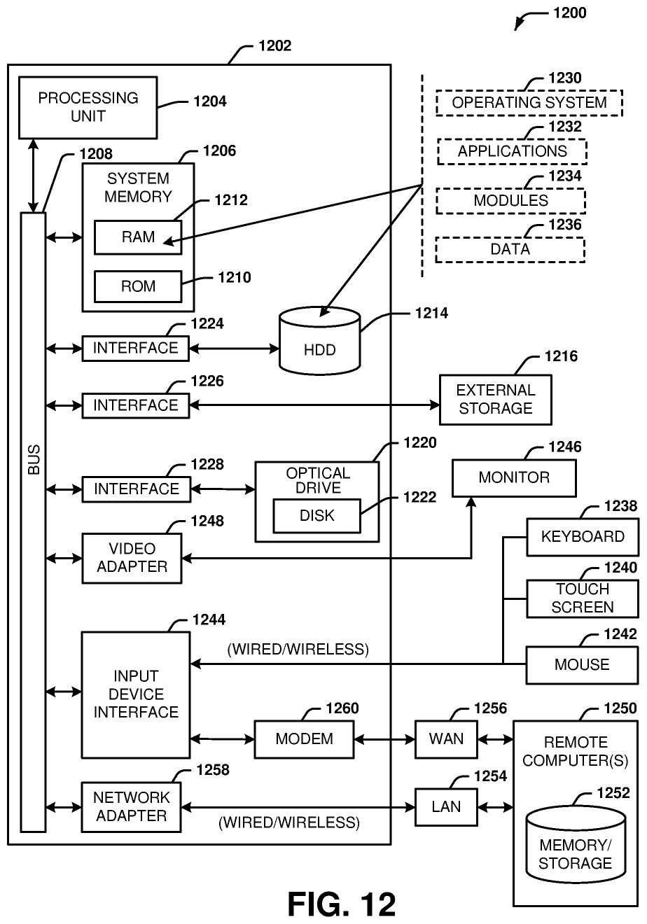

With reference now to the drawings, FIG. 1 illustrates a block diagram of a system 100 that facilitates sleep mode power saving for Layer 1 (L1) and radio unit (RU) equipment in accordance with various implementations described herein. System 100 as shown in FIG. 1 includes a mode selection component 110 and a power management component 120, each of which can operate as described in further detail below. In an implementation, the components 110, 120 of system 100 can be implemented in hardware, software, or a combination of hardware and software. By way of example, the components 110, 120 can be implemented as computer-executable components, e.g., components stored on a memory and executed by a processor. An example of a computer architecture including a processor and a memory that can be used to implement the components 110, 120, as well as other components as will be described herein, is shown and described in further detail below with respect to FIG. 12.

Additionally, it is noted that the functionality of the respective components shown and described herein can be implemented via a single computing device and/or a combination of devices. For instance, in various implementations, the mode selection component 110 shown in FIG. 1 could be implemented via a first device and the power management component 120 could be implemented via the first device or a second device. Also, or alternatively, the functionality of a single component could be divided among multiple devices in some implementations.

As further shown by FIG. 1, the mode selection component 110 and the power management component 120 can be utilized to manage the operation of physical layer equipment 10, also referred to herein as L1 equipment, that is associated with a cell 20 of a wireless communication network. By way of example, the physical layer equipment 10 can be associated with a base station, access point, and/or other device(s) that provide communication functionality for devices within the cell 20 and/or that are otherwise within a communication range of the physical layer equipment 10.

In an implementation that utilizes the Open Radio Access Network (O-RAN) standard and/or other communication standards in which functionality of a cell 20 is divided among multiple distinct devices, the physical layer equipment 10 can similarly be distributed among different devices associated with the cell 20. For example, the physical layer equipment 10 can be implemented via an accelerator card and/or other hardware at a distributed unit (DU) as well as various hardware components of an RU. Various examples of hardware configurations that can be utilized by the physical layer equipment 10 are described in further detail below.

While the mode selection component 110 and power management component 120 are shown in FIG. 1 as separate from the network cell 20 for purposes of illustration, it is noted that one or both of these components 110, 120, and/or other components that will be described below, could also be implemented by the network cell 20, e.g., via the same devices on which the physical layer equipment 10 resides and/or different devices. Additionally, while various references are made herein to specific network layers, e.g., a physical layer, data link layer, or the like, it is noted that some operations described herein could be performed via different layers in some implementations without departing from the scope of the description or the claimed subject matter. Thus, for example, the physical layer equipment 10 could be configured to perform operations with respect to layers other than the physical layer in some implementations. Other examples will be described below. It is additionally noted that the naming conventions utilized for various network layers herein are merely for descriptive purposes and are not intended to limit the description or the claimed subject matter to any particular network(s) and/or standard(s).

As noted above, under the Fifth Generation (5G) wireless communication standards, a base station will keep operating even when there are no connected active user equipment (UEs), or when the throughput and latency requirements for those UEs is low, because the base station is configured to continually transmit and receive signals that enable a UE to connect to the network. In some use cases, L1 processing associated with these signals, including L1 processing performed by RU and/or DU acceleration cards, can consume a considerable amount of the power budget, and in some cases can consume even more than the radio frequency (RF) transmitted power. Various implementations described herein can reduce the power consumption associated with L1 processing in the case where no connected UEs are active, e.g., by enabling L1 to shut down most of its processing units when no signal processing is needed.

With reference now to the components of system 100, the mode selection component 110 can set the physical layer equipment 10 in a low-power (sleep) mode based on a level of connection activity associated with the network cell 20 associated with the physical layer equipment 10. For instance, the mode selection component 110 can place the physical layer equipment 10 in a sleep mode based on an indication that a number of UEs actively connected to the network cell 20 is no greater than a threshold number. In an implementation, this indication can come from data link layer (Layer 2 or L2) equipment and/or other suitable sources, as will be described in further detail below.

In some implementations, the threshold number utilized by the mode selection component 110 as described above is zero. In such an implementation, the physical layer equipment 10 can be placed in a sleep mode in response to there being no actively connected UEs to the network cell 20. Other criteria for placing the physical layer equipment 10 in a sleep mode could also be used, such as a combined number of active and idle connections to the network cell 20 being zero or less than a threshold number, a total throughput of the network cell 20 being less than a threshold, etc.

A low-power or sleep mode managed by the mode selection component 110 can be associated with a pattern or schedule, referred to herein as a sleep pattern or a sleep schedule, that defines active and inactive time slots. The sleep pattern can be a periodic pattern and/or otherwise repeat at periodic or nonperiodic intervals. An example sleep schedule that can be utilized by system 100 is described in further detail below with respect to FIG. 3.

Based on a sleep schedule associated with the mode selection component 110, the power management component 120 of system 100 can enable and/or disable processing and communication by the physical layer equipment 10 on the active and inactive time slots of the schedule. For instance, in response to the physical layer equipment 10 being placed in a low-power mode by the mode selection component, the power management component 120 can (1) schedule communication and/or processing of network connection information by the physical layer equipment 10 during an active time slot associated with the schedule and (2) deactivate at least a portion of the physical layer equipment 10 during an inactive time slot associated with the schedule.

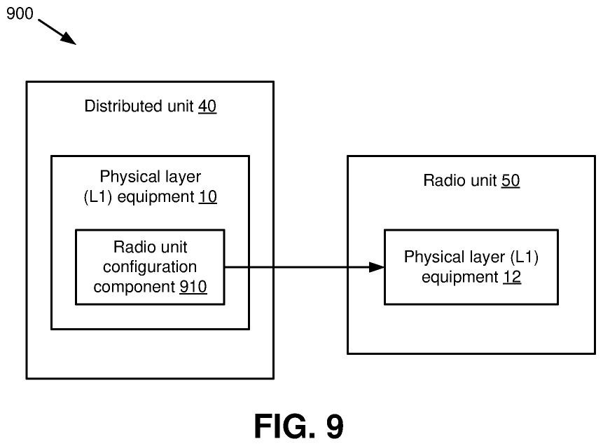

In an implementation that utilizes O-RAN technology, the L1 can be split into High L1 at the DU side and Low L1 at the RU side. An example of this split is described in further detail below with respect to FIG. 9. As used herein, High L1 is also referred to as High PHY (physical), and Low L1 is also referred to as Low PHY. Some High PHY and Low PHY equipment, such as RUs and/or accelerator cards, have the ability to shut down parts of their processing components. These can include, e.g., hardware specialized accelerators (e.g., hardware accelerator blocks such as a low-density parity check (LDPC) decoder), digital signal processing (DSP) cores or sections of multiple cores, or in some cases a complete shutdown. However, based on information conventionally shared through the O-RAN protocol between the DU and RU and/or between High L1 and L2, L1 units do not know in advance at which slots uplink (UL) and/or downlink (DL) processing is not required. As a result, an L1 unit is conventionally configured to keep all its processing units ready to be able to decode potentially high throughput at low latency, which can cause the L1 unit to consume excess energy.

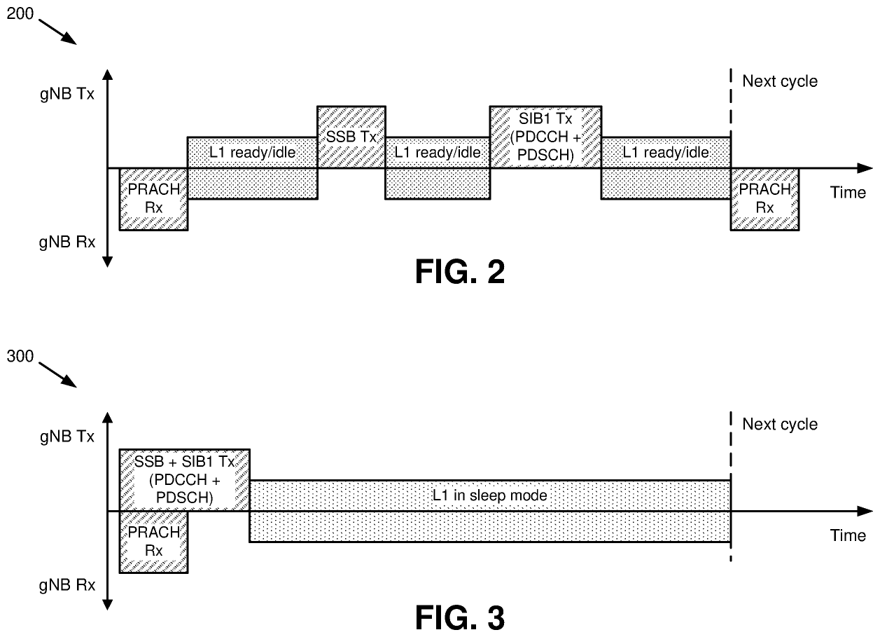

Turning now to FIG. 2, diagram 200 depicts an example of an active communication schedule that can be utilized by physical layer equipment 10. Diagram 200 is represented as a timeline, where events above the line correspond to gNodeB (gNB) transmission, events below the line correspond to gNB reception, and events centered on the line correspond to both transmission and reception. While not shown in diagram 200 for simplicity of illustration, events depicted by diagram 200 can utilize respective sets of frequency resources, which could in some implementations differ on a per-event basis. It is also noted that diagram 200 and respective diagrams that follow illustrate events that can occur within a “cycle” in time, which can correspond to a radio frame and/or span multiple radio frames.

As shown in diagram 200 for a given cycle, the physical layer equipment 10 can be configured to receive messages from UEs and/or other devices over a Physical Random Access Channel (PRACH), e.g., to facilitate connecting new UEs and/or other devices to the network. The physical layer equipment 10 also transmits system information messages to further facilitate connecting new devices to the network, such as a Synchronization Signal Block (SSB) and an initial System Information Block (SIB1). As additionally shown by diagram 200, SIB1 could be transmitted via a control channel such as a Physical Downlink Control Channel (PDCCH), a data channel such as a Physical Downlink Shared Channel (PDSCH), or a combination of control and/or data channels.

In current communication standards, such as O-RAN, Femto Application Platform Interface (FAPI), etc., there is no option to indicate a specific sleep pattern at which both high and low PHY (e.g., RU and DU components) could use the inactivity for a shutdown and reduce power consumption. As a result, L1 will stay at full capacity ready to process maximal throughput at minimum latency, as shown by the regions in diagram 200 where L1 remains ready and idle. This, in turn, results in L1 consuming high power levels.

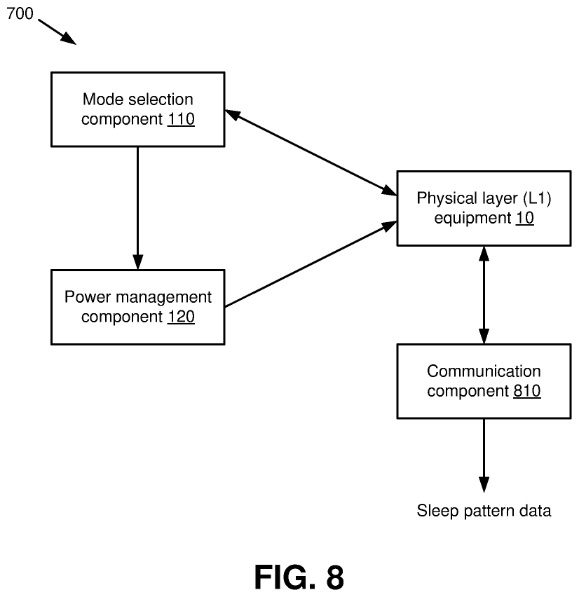

In contrast to the active schedule shown in diagram 200, diagram 300 in FIG. 3 depicts an example sleep schedule that can be utilized by physical layer equipment 10 in various implementations. Here, a special configuration of network connection messages, e.g., SIB1, SSB, and PRACH, can be scheduled within a common slot or set of slots, e.g., the same slot in frequency division duplex (FDD) mode or on two subsequent slots in time division duplex (TDD) mode. Outside of the active slot(s) on which these messages are communicated, the physical layer equipment 10 can be placed into sleep mode, e.g., by powering down and/or otherwise deactivating at least a portion of the physical layer equipment 10. To facilitate a condensed communication schedule such as that shown by diagram 300, the configuration of the SIB1, SSB, and PRACH messages can be announced to future UEs in SIB1, e.g., as will be described in further detail below with respect to FIG. 8.

By locating all L1 channels at the same time period as shown by diagram 300, the amount of time during which L1 can be in a low-power state can be increased, e.g., relative to a configuration such as that shown by diagram 200 in which the L1 channels are allowed to spread over multiple slots. Additionally, utilizing a comparatively long sleep period relative to the L1 channels can also reduce the amount of power consumption associated with transitioning in and out of sleep mode, as these transitions can take a nontrivial amount of time. To facilitate the concentration of L1 channels in time as shown by diagram 300, the network can utilize proposed new Third Generation Partnership Project (3GPP) PRACH configurations, e.g., as will be described in further detail below.

Diagram 300 illustrates an example sleep schedule for a system that utilizes FDD, where all UL and DL processing is concentrated into a single active time slot. Alternatively, for a system utilizing TDD, the UL and DL processing shown in diagram 300 could instead occur on two temporally adjacent active time slots. Other configurations are also possible.

In some implementations, physical layer equipment 10 can be configured to operate according to the sleep schedule shown in FIG. 3 in cases in which a cell has no actively connected UEs. For instance, in an implementation utilizing 5G technology, the schedule shown in FIG. 3 can be used when a cell has no UEs in RRC_CONNECTED mode, e.g., all UEs in the cell, if any, are in RRC_INACTIVE mode or in RRC_IDLE mode. In such a case, the cell L1 functions could be limited to the following:
1) Transmission of broadcast channel SSB at intervals of a period, e.g., every 20 ms for a standalone 5G cell. Other channels utilized by the cell during sleep mode can have longer time periods, resulting in the period for SSB being the maximum sleep/wake cycle length.
2) Transmission of broadcast channel SIB1. At the L1 side, this channel can map to PDCCH and/or PDSCH, as shown in FIG. 3.
3) Transmission of a per-UE paging channel, e.g., at a given periodicity configured by L2, and potentially containing data or no transmission depending on need. At the L1 side, this channel can also map to PDCCH and/or PDSCH.
4) Reception of PRACH. Similar to the other functions noted above, PRACH can also have a configurable periodicity and time offsets.

Since waking up L1 processing components is associated with a transmission time, keeping the duration of the sleep time longer, e.g., as shown in FIG. 3, can improve power consumption of the associated equipment.

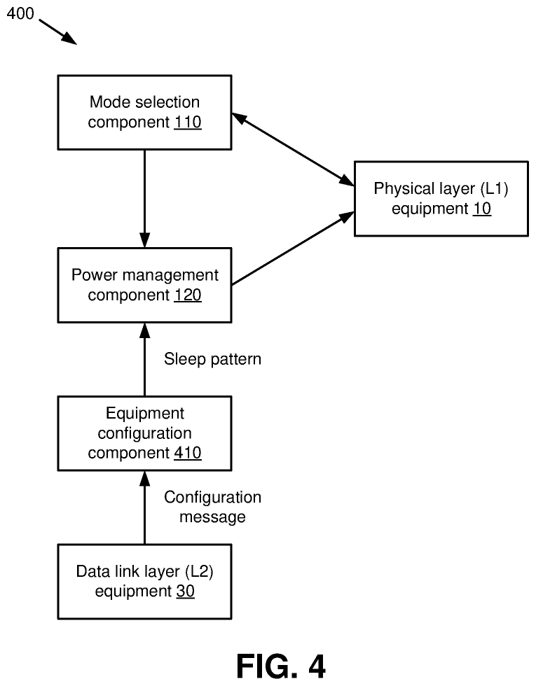

Turning now to FIG. 4, a block diagram of another system 400 that facilitates sleep mode power saving for L1 and RU equipment is illustrated. Repetitive description of like parts described above with regard to other implementations is omitted for brevity. System 400 as shown in FIG. 4 includes a mode selection component 110 and a power management component 120 that can set a communication schedule for physical layer equipment 10, e.g., an active schedule as shown in FIG. 2 or a sleep schedule as shown in FIG. 3, in a similar manner to that described above with respect to FIG. 1. System 400 further includes an equipment configuration component 410 that can receive information associated with the sleep schedule for the physical layer equipment 10, or periodic patterns associated with such a schedule, from data link layer equipment 30, also referred to herein as L2 equipment.

In an implementation, a sleep pattern for the physical layer equipment 10 can be provided in a configuration message that is transmitted from the data link layer equipment 30 to the equipment configuration component 410 during a configuration phase for the physical layer equipment 10. In an implementation in which FAPI and/or other similar standards are used, this configuration phase can occur prior to the physical layer equipment 10 being activated to serve network traffic. Alternatively, the configuration phase can be a reconfiguration phase in which the physical layer equipment 10 is temporarily removed from the network, reconfigured, and reactivated. In still other implementations, information regarding the sleep pattern can be received via the equipment configuration component 410 at any suitable time, including during runtime of the physical layer equipment 10.

In some implementations, a configuration message provided by data link layer equipment 30 as described above can include information relating to a length of the sleep pattern (e.g., a period length) and a bitmap and/or other indication of the positions of active and inactive time slots within the sleep pattern. A non-limiting example format that can be utilized by the data link layer equipment 30 for the configuration message can include the following fields:
1) Periodicity—Expresses the length of the wake pattern in slots or other units, and also conveys the length of the configuration message. In some implementations, the periodicity is a configurable value that can range between 2 to 65536 units. Larger periods are also possible.
2) Wake pattern—A bitmap of a length equal to the periodicity value multiplied by 2 that indicates whether respective slots in the pattern are active or inactive. An example bitmap format that can indicate whether slots are active or inactive on both the uplink and downlink is given by Table 1 below:

TABLE 1
Example bitmap format for configuration message.

| Value | Indication |
|---|---|
| 00 | No UL or DL on the slot |
| 01 | Only DL on the slot |
| 10 | Only UL on the slot |
| 11 | Both UL and DL on the slot |

At the time the equipment configuration component 410 receives the configuration message, the physical layer equipment 10 can be further configured to not change its behavior until further instructions are received from the data link layer equipment 30. Subsequently, e.g., in response to the data link layer equipment 30 determining that there are no UEs actively connected to an associated cell, the data link layer equipment 30 can send a message to the equipment configuration component 410 announcing that the physical layer equipment 10 can from that moment forward follow the configured sleep pattern. This message can be, e.g., a special message through O-RAN, FAPI, and/or other suitable standards that configures L1 to wake up only on the active slots shown in diagram 300 to process the DL and UL channels.

As a result of being placed into sleep mode, the physical layer equipment 10 can take advantage of the sleep time to shut down its processing relating to receiving messages from L2 and/or processing UL or DL packets from an associated RU. In an implementation, while in sleep mode, the physical layer equipment 10 can be configured to receive messages from the data link layer equipment 30 only during awake slots. To return the physical layer equipment 10 to an active mode, the data link layer equipment 30 can send a notification at any configured wake-up slot to the equipment configuration component 410 that indicates that the sleep pattern is to be turned off.

Returning to FIG. 3, present 3GPP standards do not contain the PRACH configurations associated with packing UL/DL processing into a single slot, e.g., as shown by diagram 300. Therefore, even if the proper messages were sent from L2 to let L1 know when it could go into sleep mode, present 3GPP standards to not provide the ability to concentrate a wake period in a single time slot. By way of example, PRACH format B4 does not allow for PRACH and SSB to collocate the same slot in FDD (e.g., slot 0 and slot 1 of subframe number 0), which results in less optimal power saving.

In view of the above, physical layer equipment 10 as described herein can operate according to alternative 3GPP PRACH patterns that can allow the concentration of all processing associated with a cell without active UEs, or UEs without high throughput requirements. A non-limiting listing of example alternative PRACH patterns is given by Table 2 below for respective PRACH preamble formats. As Table 2 shows, while a utilized preamble format can differ, e.g., due to properties of an associated cell, each format can concentrate all processing into subframe 0 (e.g., in slot 0 only for FDD and/or slots 0 and 1 for TDD, etc.).

TABLE 2
Example PRACH preamble formats supporting sleep mode.

| Preamble format | Subframe number | Slots |
|---|---|---|
| 0 | 0 | 0 or 1 |
| 1 | 0 | 0 or 1 |
| 2 | 0 | 0 or 1 |
| 3 | 0 | 0 or 1 |
| A1 | 0 | 0 or 1 |
| A2 | 0 | 0 or 1 |
| A3 | 0 | 0 or 1 |
| B1 | 0 | 0 or 1 |
| B4 | 0 | 0 or 1 |
| C0 | 0 | 0 or 1 |
| C2 | 0 | 0 or 1 |

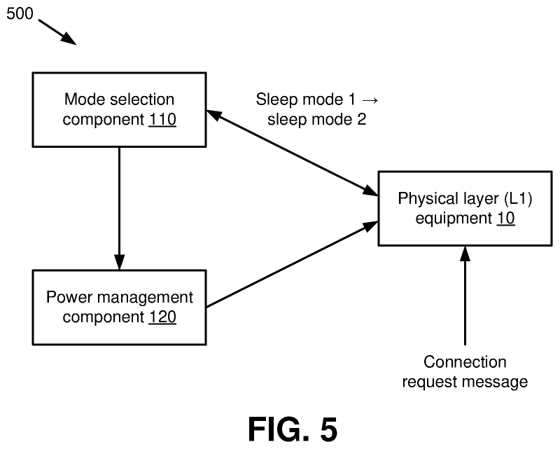

With reference now to FIG. 5, a block diagram of an additional system 500 that facilitates sleep mode power saving for L1 and RU equipment is illustrated. Repetitive description of like parts described above with regard to other implementations is omitted for brevity. As shown by FIG. 5, physical layer equipment 10 associated with system 500 can be placed into a sleep mode, e.g., in the manner described above with respect to FIG. 1. This sleep mode is shown in FIG. 5 as a first sleep mode (sleep mode 1). While the physical layer equipment 10 is in the first sleep mode, the mode selection component 110 can transition the physical layer equipment 10 from the first sleep mode to a second sleep mode (shown as sleep mode 2 in FIG. 5) in response to the physical layer equipment 10 detecting a connection request message, e.g., during the active time slot for PRACH reception shown in FIG. 3.

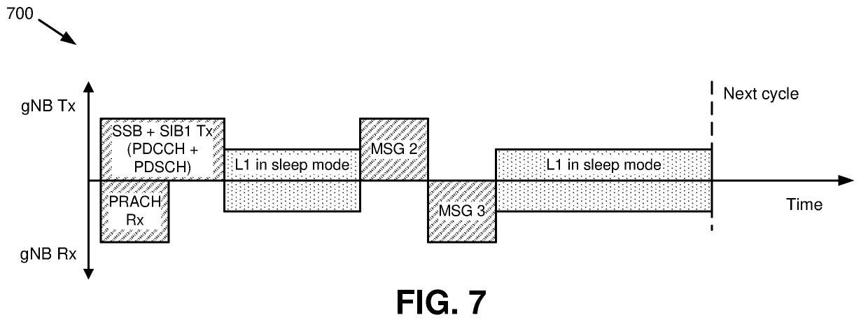

In some implementations, information relating to a wake pattern for the second sleep mode can be provided by data link layer equipment 30 in a similar manner to that described above with respect to FIG. 4 for the first sleep pattern, e.g., via a configuration message including a bitmap indicative of active and inactive time slots within the pattern. A wake pattern for the second sleep mode can be provided at the same time as the wake pattern for the first sleep mode and/or at a different time. In one implementation, the second sleep mode can be scheduled independently of the first sleep mode, e.g., with active and inactive time slots that do not necessarily correspond to any active or inactive time slots of the first sleep mode. Alternatively, the second sleep schedule can be based on the first sleep schedule, e.g., by modifying the first sleep schedule to convert at least one inactive time slot in the first sleep schedule to an additional active time slot. An example configuration that can be utilized for the second sleep mode is described in further detail below with respect to FIG. 7.

In various implementations, operation of the physical layer equipment 10 in the event of a detected connection request message can be dependent on whether a second sleep mode is supported by the underlying network. For instance, if a second pattern is supported, L2 can send the second sleep pattern to a High PHY component of a DU and/or to an RU, e.g., as described above. The High PHY can then switch to the second sleep pattern when a PRACH or other suitable message is detected. Additionally, High PHY can also send a Low PHY component of an RU a signal to enable the RU to switch to the secondary pattern. An example message exchange between a DU and RU in this manner is described in further detail below with respect to FIG. 9.

If, instead, a second sleep mode is not supported by the underlying network, the physical layer equipment 10 can turn off its sleep pattern and wake up (i.e., enter an active mode) in response to a PRACH or other suitable message being detected. Additionally, a High PHY component of a DU can send a Low PHY component of an RU a signal to instruct the RU to turn off its sleeping pattern.

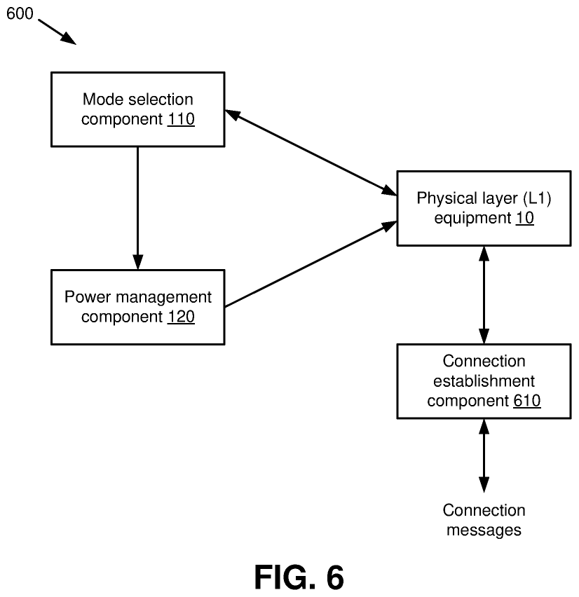

As further shown by system 600 in FIG. 6, in response to the physical layer equipment 10 detecting a PRACH message and/or other connection request message, a connection establishment component 610 associated with the physical layer equipment 10 can initiate a device connection procedure, e.g., to facilitate connecting a source of the PRACH message to the network. In an implementation in which the network utilizes a second sleep mode as described above, the connection establishment component 610 can initiate a message exchange on the active time slots associated with the second sleep pattern. Diagram 700 in FIG. 7 illustrates an example communication schedule for the second sleep mode, where MSG 2 and MSG 3 represent the respective messages exchanged via the physical layer equipment 10 in response to a PRACH being detected.

In an implementation that utilizes a second sleep mode as described above, the physical layer equipment 10 can transition from the second sleep mode to another operating mode after the connection procedure initiated by the connection establish component 610. For instance, if the connection establishment component 610 determines that a detected PRACH was a false positive after several attempts to establish a connection with a UE, the mode selection component 110 can transition the physical layer equipment 10 from the second sleep mode back to the first sleep mode, e.g., based on a message sent from data link layer equipment as described above with respect to FIG. 4. If, alternatively, the device connection procedure is determined to have successfully completed, the mode selection component 110 can instead transition the physical layer equipment 10 from the second sleep mode to an active mode.

In some implementations, the detection threshold for PRACH messages can be significantly less than that associated with other messages exchanged via the network. As a result, system noise could in some cases present as a false positive. Depending on the configuration of the system false PRACH detections can be relatively common, e.g., on the order of 0.1 percent of all PRACH detections. Because PRACH false detections occur even if no real UE is trying to connect, entering a second sleep pattern instead of fully activating in response to PRACH detection can provide additional power savings in the case of a false alarm.

Turning now to FIG. 8, a block diagram of still another system 800 that facilitates sleep mode power saving for L1 and RU equipment is illustrated. Repetitive description of like parts described above with regard to other implementations is omitted for brevity. System 800 as shown in FIG. 8 includes a communication component 810, associated with the physical layer equipment 10, that can facilitate transmission of data relating to the sleep/wake pattern utilized by the physical layer equipment 10 during an active time slot, e.g., the active transmission slot shown in FIG. 3. By indicating the active time slot via the communication component 810, UEs and/or other devices seeking to connect to the physical layer equipment 10 can be configured to send PRACH transmissions at a time in which the physical layer equipment 10 will be active even while in sleep mode.

With reference next to FIG. 9, a block diagram of a further system 900 that facilitates sleep mode power saving for L1 and RU equipment is illustrated. Repetitive description of like parts described above with regard to other implementations is omitted for brevity. System 900 as shown in FIG. 9 includes a DU 40 and an RU 50, each of which being associated with respective physical layer equipment 10, 12. As noted above, the physical layer equipment 10 of the DU 40 is referred to as High PHY equipment, and the physical layer equipment 12 of the RU 50 is referred to as Low PHY equipment. In an implementation, the physical layer equipment 10 of the DU 40 can be implemented via an accelerator card and/or other suitable physical components associated with the DU 40. Additionally, the DU 40 and RU 50 shown in system 900 can be physically separate entities that communicate with each other through a wired or wireless fronthaul link.

As further shown by FIG. 9, the physical layer equipment 10 of the DU 40 can include and/or otherwise be associated with an RU configuration component 910 that can convey information relating to one or more sleep patterns to the physical layer equipment 12 of the RU 50, e.g., to inform the RU 50 of the sleep pattern(s). In an implementation, the RU configuration component 910 can utilize one or more messages that are similar to messages provided by data link layer equipment 30 as described above with respect to FIG. 4. These messages can be provided to the physical layer equipment 12 of the RU 50 in any suitable manner, e.g., over the O-RAN M-plane. Based on the message(s) provided by the RU configuration component 910, the RU 50 can utilize the sleep pattern to save power by shutting off some of its processing components during inactive time slots.

In some implementations, a sleep mode as described herein could be supported by one or both of the DU 40 and RU 50. If one of the two supports this capability and the other does not, the sleep pattern can be utilized by the supporting component and disregarded by the non-supporting component.

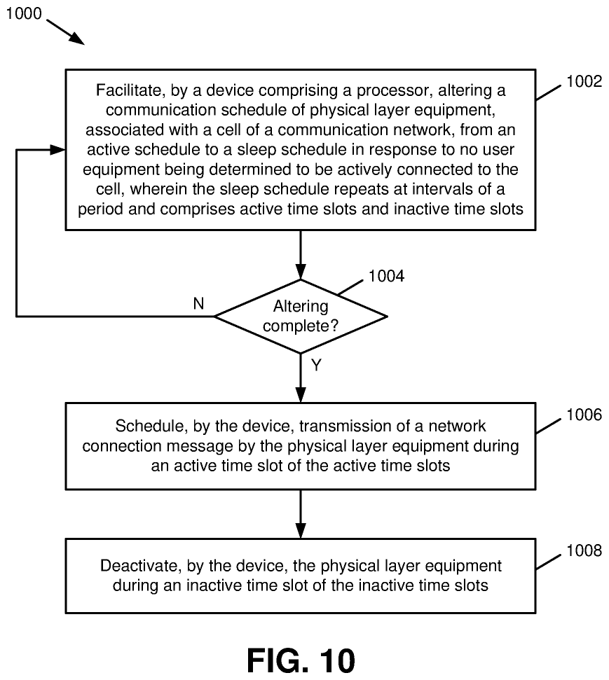

Turning to FIG. 10, a flow diagram of a method 1000 that facilitates sleep mode power saving for L1 and RU equipment is illustrated. At 1002, a device comprising a processor can facilitate (e.g., by a mode selection component 110) altering a communication schedule of physical layer equipment (e.g., physical layer equipment 10) associated with a cell (e.g., network cell 20) of a communication network from an active schedule to a sleep schedule in response to no user equipment being determined to be actively connected to the cell. The sleep schedule can repeat at intervals of a period and include active time slots and inactive time slots.

At 1004, operation of method 1000 can be held pending completion of the altering at 1002. Upon altering of the schedule of the physical layer equipment at 1002 being completed, method 1000 can proceed to 1006, in which the device schedules (e.g., by a power management component 120) transmission of a network connection message by the physical layer equipment during an active time slot of the active time slots, and to 1008, in which the device deactivates (e.g., by the power management component 120) the physical layer equipment during an inactive time slot of the inactive time slots.

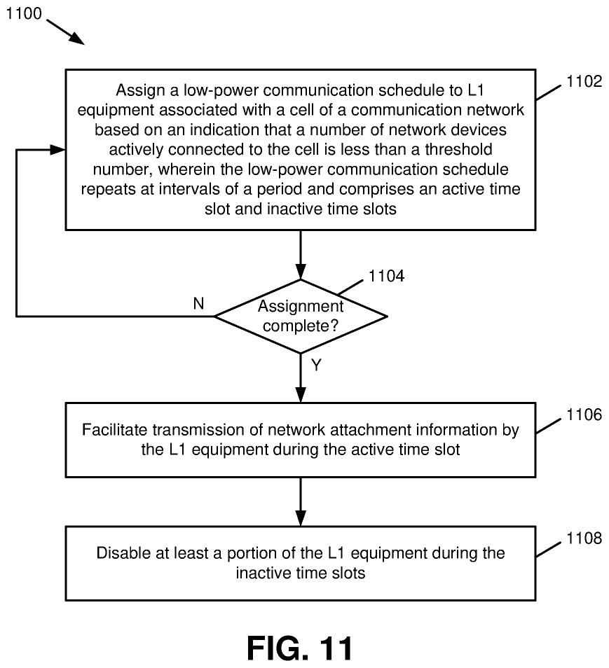

Referring next to FIG. 11, a flow diagram of a method 1100 that can be performed by a processor, e.g., based on machine-executable instructions stored on a non-transitory machine-readable medium, is illustrated. An example of a computer architecture, including a processor and non-transitory media, that can be utilized to implement method 1100 is described below with respect to FIG. 12.

Method 1100 can begin at 1102, in which the processor can assign a low-power communication schedule to L1 equipment associated with a cell of a communication network based on an indication that a number of network devices actively connected to the cell is less than a threshold number. The low-power communication schedule can repeat at intervals of a period and include an active time slot and inactive time slots.

At 1104, operation of method 1100 can be held pending completion of the assignment performed at 1102. Upon the assignment at 1102 being completed, method 1100 can proceed to 1106, in which the processor can facilitate transmission of network attachment information by the L1 equipment during the active time slot, and to 1108, in which the processor can disable at least a portion of the L1 equipment during the inactive time slots.

FIGS. 10-11 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD), a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory that stores executable components; and
a processor that executes the executable components stored in the memory, wherein the executable components comprise:
a mode selection component that sets physical layer equipment, associated with a cell of a communication network, in a low-power mode based on an indication that a number of user equipment devices actively connected to the cell is no greater than a threshold number, wherein the low-power mode is associated with a periodic pattern comprising an active time slot and an inactive time slot; and
a power management component that, in response to the physical layer equipment being set in the low-power mode, schedules communication of network connection information by the physical layer equipment during the active time slot and deactivates at least a portion of the physical layer equipment during the inactive time slot.

2. The system of claim 1, wherein the executable components further comprise:
an equipment configuration component that receives the periodic pattern via a configuration message provided by data link layer equipment.

3. The system of claim 2, wherein the configuration message comprises a length of the periodic pattern and a bitmap, the bitmap indicating a first position of the active time slot relative to the periodic pattern and a second position of the inactive time slot relative to the periodic pattern.

4. The system of claim 1, wherein:
the low-power mode is a first low-power mode,
the periodic pattern is a first periodic pattern,
the active time slot is a first active time slot,
the mode selection component transitions the physical layer equipment from the first low-power mode to a second low-power mode in response to the physical layer equipment detecting a connection request message during the first active time slot while in the first low-power mode, and
the second low-power mode is associated with a second periodic pattern comprising the first active time slot, a second active time slot that is not the first active time slot, and the inactive time slot.

5. The system of claim 4, wherein the executable components further comprise:
a connection establishment component that, in response to the detecting of the connection request message, initiates a device connection procedure.

6. The system of claim 5, wherein the mode selection component transitions the physical layer equipment from the second low-power mode to the first low-power mode in response to the device connection procedure being determined to have not successfully completed within a defined time interval.

7. The system of claim 5, wherein the mode selection component transitions the physical layer equipment from the second low-power mode to an active mode in response to the device connection procedure being determined to have successfully completed.

8. The system of claim 1, wherein the physical layer equipment utilizes time division duplexing, wherein the active time slot is a first active time slot, and wherein the periodic pattern further comprises a second active time slot that is temporally adjacent to the first active time slot.

9. The system of claim 1, wherein the network connection information comprises a system information block, and wherein the executable components further comprise:
a communication component that facilitates transmission of data relating to the periodic pattern with the system information block during the active time slot.

10. The system of claim 1, wherein the physical layer equipment is first physical layer equipment and associated with distributed unit equipment, and wherein the executable components further comprise:
a radio unit configuration component that conveys the periodic pattern from the first physical layer equipment to second physical layer equipment associated with radio unit equipment.

11. A method, comprising:
facilitating, by a device comprising a processor, altering a communication schedule of physical layer equipment, associated with a cell of a communication network, from an active schedule to a sleep schedule in response to no user equipment being determined to be actively connected to the cell, wherein the sleep schedule repeats at intervals of a period and comprises active time slots and inactive time slots; and
in response to the facilitating of the altering,
scheduling, by the device, transmission of a network connection message by the physical layer equipment during an active time slot of the active time slots, and
deactivating, by the device, the physical layer equipment during an inactive time slot of the inactive time slots.

12. The method of claim 11, further comprising:
receiving, by the device, the sleep schedule via a configuration message provided by data link layer equipment, the configuration message comprising a length of the period and a bitmap indicative of positions of the active time slots and the inactive time slots within the sleep schedule.

13. The method of claim 11, wherein the active time slot is a first active time slot, wherein the inactive time slot is a first inactive time slot, and wherein the method further comprises:
modifying, by the device in response to the physical layer equipment detecting a connection request message during the first active time slot while using the sleep schedule, the sleep schedule by converting at least one second inactive time slot of the inactive time slots to a second active time slot of the active time slots, resulting in a modified sleep schedule.

14. The method of claim 13, further comprising:
facilitating, by the device in response to the detecting of the connection request message, initiating a connection establishment procedure by the physical layer equipment.

15. The method of claim 14, further comprising:
returning, by the device in response to the connection establishment procedure being determined not to have successfully completed within a time interval, the communication schedule of the physical layer equipment to the sleep schedule from the modified sleep schedule.

16. The method of claim 11, wherein the physical layer equipment is first physical layer equipment of distributed unit equipment, and wherein the method further comprises:
conveying, by the device, the sleep schedule from the first physical layer equipment to second physical layer equipment of radio unit equipment.

17. A non-transitory machine-readable medium comprising computer executable instructions that, when executed by a processor, facilitate performance of operations, the operations comprising:
assigning a low-power communication schedule to Layer 1 equipment associated with a cell of a communication network based on an indication that a number of network devices actively connected to the cell is less than a threshold number, wherein the low-power communication schedule repeats at intervals of a period and comprises an active time slot and inactive time slots; and
in response to the assigning,
facilitating transmission of network attachment information by the Layer 1 equipment during the active time slot, and
disabling at least a portion of the Layer 1 equipment during the inactive time slots.

18. The non-transitory machine-readable medium of claim 17, wherein the operations further comprise:
receiving a configuration message from Layer 2 equipment, the configuration message comprising a length of the period and a bitmap indicative of positions of the active time slot and the inactive time slots within the low-power communication schedule.

19. The non-transitory machine-readable medium of claim 17, wherein the low-power communication schedule is a first low-power communication schedule, wherein the active time slot is a first active time slot, and wherein the operations further comprise:
in response to the Layer 1 equipment detecting a connection request message during the first active time slot while using the first low-power communication schedule, converting an inactive time slot of the inactive time slots within the first low-power communication schedule to a second active time slot, resulting in a second low-power communication schedule.

20. The non-transitory machine-readable medium of claim 19, wherein the operations further comprise:
in response to the detecting of the connection request message, initiating a connection establishment procedure by the Layer 1 equipment during the second active time slot; and
in response to failure of the connection establishment procedure, returning the Layer 1 equipment to the first low-power communication schedule.
